(19) United States
(12) Patent Application Publication
(10) Pub. No.: US 2017/0271724 A1
(43) Pub. Date: Sep. 21, 2017

(54) Lithium Ion Cell

(71) Applicant: Bayerische Motoren Werke Aktiengesellschaft, Muenchen (DE)

(72) Inventors: Jan Philipp SCHMIDT, Muenchen (DE); Nikolaos TSIOUVARAS, Muenchen (DE)

(21) Appl. No.: 15/617,413

(22) Filed: Jun. 8, 2017

Related U.S. Application Data
(63) Continuation of application No. PCT/EP2015/077344, filed on Nov. 23, 2015.

(30) Foreign Application Priority Data
Dec. 10, 2014 (DE) 10 2014 225 451.5

(51) Int. Cl. H01M 10/42; H01M 2/16; H01M 10/0585; H01M 10/0525

(52) U.S. Cl. CPC H01M 10/4235; H01M 10/0525; H01M 2/1653; H01M 2/1686; H01M 10/0585; H01M 2200/00

(57) ABSTRACT

A lithium ion cell has two opposite electrodes that are oppositely polarized and are separated from each other by a porous separator which is permeable to lithium ions and which is designed as an at least triple-layered composite element. One of the layers of the separator is an electrically conductive, porous sensor layer, on both sides of which electronically insulating layers permeable to lithium ions are disposed and which is connected to at least one of the electrodes via a resistance measuring device.

### CROSS REFERENCE TO RELATED APPLICATIONS

This application is a continuation of PCT International Application No. PCT/EP2015/077344, filed Nov. 23, 2015, which claims priority under 35 U.S.C. §119 from German Patent Application No. 10 2014 225 451.5, filed Dec. 10, 2014, the entire disclosures of which are herein expressly incorporated by reference.

### BACKGROUND AND SUMMARY OF THE INVENTION

The invention relates to a lithium ion cell having two electrodes of differing polarity which are located opposite one another and are separated from one another by a porous separator which is permeable to lithium ions, wherein the separator is configured as an at least three-layer composite element.

Such lithium ion cells are known from WO 2010/130339 A1.

Lithium ion cells are known as rechargeable high-performance energy stores in many electronic appliances. Owing to their high energy density, they are also used as energy stores in motor vehicles having a hybrid or purely electric drive.

In terms of their typical structure, lithium ion cells have two electrodes of differing polarity which are each able to release or bind lithium ions depending on the prevailing voltage conditions. The release or uptake of the lithium ions occurs into or from an electrolyte which, however, does not participate directly in the actual binding or release processes. In order to avoid a short circuit between the electrodes, a separator which is permeable to the migrating lithium ions but represents an electronically insulating separation layer between the electrodes is arranged between the electrodes. The separator is frequently a porous layer composed of an electrically nonconductive polymer. The abovementioned document discloses configuring the separator as three-layer composite element, with in particular an oxidic, inorganic stabilizing layer being flanked on both sides by a polyetherimide layer. The electronically insulating polymer layers form a chemically inert protection for the stabilizing layer which is itself also electronically insulating. The key task of the stabilizing layer is to increase the mechanical strength of the lithium ion cell to protect against damage and punctures.

Dendrite growth can be a problem in lithium ion cells. Dendrites are finger-like growths which are formed when lithium ions crystallize out on an electrode, in particular the anode. If such dendrite growth remains unnoticed, dendrites can puncture the separator and trigger a short circuit between the electrodes. However, if the dendrites are noticed in good time, their growth can be countered by suitable battery management.

It is an object of the present invention to develop generic lithium ion cells further in such a way that dendrite growth can be detected at an early stage.

This and other objects are achieved by a lithium ion cell comprising two electrodes of differing polarity which are located opposite one another and are separated from one another by a porous separator which is permeable to lithium ions, wherein the separator is configured as an at least three-layer composite element. One of the layers of the separator is an electrically conductive porous sensor layer which is flanked on both sides by electronically insulating layers permeable to lithium ions and is connected via a resistance measuring device to at least one of the electrodes.

If a dendrite grows to such an extent that it punctures the electrically insulating protective layer of the separator and comes into contact with the sensor layer, the breakdown of the resistance between the concerned electrode and the separator can be detected by way of the resistance measuring device. Accordingly, suitable countermeasures can be initiated via the battery management. It is important here that the short circuit between the concerned electrode and the separator brought about in this way does not lead to failure of the total lithium ion cell; this would occur only in the case of a short circuit between the two electrodes, which at the point-in-time at which dendrites are detected is not yet present. The invention thus makes early detection of dendrite growth possible, so that countermeasures can be initiated when there is not yet any acute danger of permanent damage to the cell.

The sensor layer advantageously consists of an electrically conductive polymer material. For example, a polyaniline, a polypyrrole or a polythiophene can be used here. These materials have been found to be particularly useful, as will be discussed further below.

As an alternative, it is also possible for the conductive sensor layer to consist of a metallically modified, nonconducting polymer material. For example, an electrically nonconducting polymer film can be provided with a metal layer by vapor deposition or be modified in another way. However, the production of such polymer films is complicated and expensive, and the abovementioned alternative is therefore preferred.

The use of a metallic layer which is perforated by pores and is embedded between the two electrically insulating protective layers is also contemplated in principle. However, this variant is even more unfavorable than the abovementioned variant in terms of production costs and weight.

The embodiments of the invention which concern the configuration of the conductive sensor layer using a polymer material are particularly advantageous with respect to the ion permeability of the separator. In particular, the polymer material can be configured as a porous membrane. The porosity of the membrane allows the lithium ions to permeate through the separator in high density, which is an absolute necessity for a high battery current. It is considered to be particularly advantageous for the polymer material to be configured as a stretched film. This is because stretching of polymer films makes it possible to produce porous membranes. The mechanical stresses which have to be applied during stretching in order to produce a membrane having the desired porosity are known in principle to those skilled in the art.

In this connection, it also becomes clear why embodiments of the invention in which the conductive sensor layer consists of an electrically conductive polymer material are preferred. The electrical conductivity of this material is not changed or changed only minimally by stretching. In contrast, the conductivity of metallically coated films can deteriorate upon stretching if the metallic coating tears. However, if coating is carried out only after stretching, there is a risk of the pores being closed by the coating metal.

The resistance measuring device together with a control connected thereto and a transmitter unit connected to the control is advantageously integrated at a distance from the electrodes into a battery housing surrounding the electrodes and the separator, wherein resistance measurements by the resistance measuring device can be initiated by way of the control and resistance values determined by the resistance measuring device or a parameter derived therefrom can be communicated via the transmitter unit to an external receiver unit. Lithium ion cells are typically equipped with a complex control in any case. This is frequently realized in the form of an integrated circuit which is built into the battery housing. The abovementioned embodiment of the invention then provides for the resistance measuring device according to the invention likewise to be integrated here and for a transmitter unit by which the resistance values determined according to the invention or parameters derived therefrom, for example a warning signal for a user, can be communicated to an external control to be additionally provided. The external control has an appropriate receiver unit for this purpose. Different variants are contemplated for this communication. In a preferred embodiment, the transmitter unit is configured as a radio transmitter unit, so that the resistance values determined by the resistance measuring device or the parameter derived therefrom can be communicated by radio signal to the external receiver unit. Separate wiring becomes superfluous here, so that lithium ion cells according to the invention can readily be replaced by conventional lithium ion cells and vice versa. Whether or not use can be made of the invention in terms of the external control then depends only on whether the external control has a suitable radio receiver unit.

As an alternative, it is also possible for the transmitter unit to include a modulator and be connected to a direct current outlet lead of one of the electrodes in such a way that the resistance values determined by the resistance measuring unit or the parameter derived therefrom can be communicated as a modulation signal imposed on a direct current voltage of the electrode to the external receiver unit. In this embodiment, a wired connection, which is in any case present, is used for communication of the data. In this variant, too, no separate wiring is required. The usability of the invention instead depends solely on a receiver device with a demodulator which is necessary on the part of the external control.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a schematic depiction of a lithium ion cell according to an embodiment of the invention.

### DETAILED DESCRIPTION OF THE DRAWING

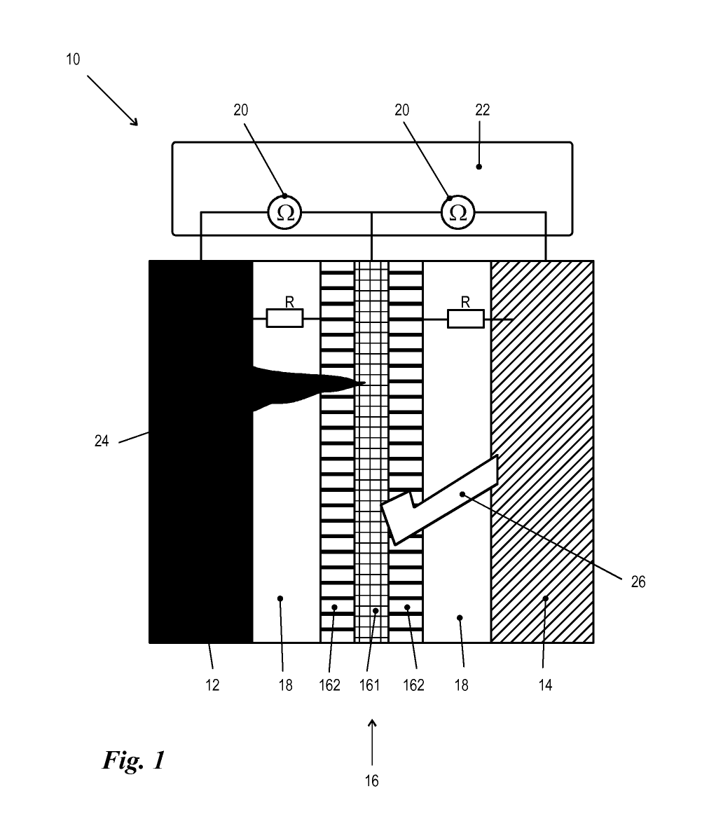

FIG. 1 shows a schematic depiction of a lithium ion cell 10 according to an embodiment of the invention. The cell 10 comprises a first electrode 12 and a second electrode 14 which are arranged opposite one another and have different polarities. A separator 16, configured as three-layer composite element, is arranged between the electrodes 12, 14. As a central layer, the separator 16 has an electrically conductive sensor layer 161 which preferably consists of an electrically conductive polymer material which is particularly preferably a porous membrane in the form of a stretched film. The sensor layer 161 is flanked on both sides by electrically insulating polymer layers 162 which are preferably likewise configured as porous membranes, particularly preferably as stretched films.

Between the electrodes 12, 14 and the separator 16 there is the electrolyte 18 with which the electrodes 12, 14 and the separator 16 are preferably impregnated. Owing to the electronically insulating polymer layers 162, there is an essentially infinitely high resistance R between the electrically conductive sensor layer 161 and the electrodes 12, 14. This is indicated by the resistance symbol R in FIG. 1. A person skilled in the art will understand that the resistances R depicted are not separate components. Each electrode 12, 14 is connected to the sensor layer 161 via a resistance measuring device 20 which is integrated into a more complex battery management unit. The battery management unit 22 is not shown in detail. It is preferably an integrated circuit which is embedded into a housing (not shown) of the lithium ion cell 10.

The growth of a dendrite 24 on the electrode 12 is indicated on the left-hand side of FIG. 1. In the state depicted, the dendrite has already penetrated through the left-hand protective layer 162 of the separator 16 and contacts the sensor layer 161. This leads to a breakdown of the corresponding resistance R, which can be detected by the resistance measuring device 20. On the basis of such a detection, measures countering the dendrite growth can be undertaken by the battery management unit 22. The phenomenon can also be communicated via specifically provided channels to an external control (not shown), for example by radio signal or via a signal modulated onto the direct current voltage of the cell 10.

A similar scenario is shown on the right-hand side of FIG. 1. However, it is not the growth of a dendrite which is indicated here but instead the formation of a short circuit between the right-hand side electrode 14 and the sensor layer 161 as a result of an electrically conductive, in particular metallic, foreign body 26 which has penetrated into the electrolyte 18. This also leads to a breakdown of the corresponding resistance, here the resistance between the right-hand electrode 14 and the sensor layer 161. When this phenomenon is appropriately communicated to an external control, a warning signal for a user can be emitted or an apparatus powered by the cell 10 can be switched off.

### LIST OF REFERENCE NUMERALS

10 Lithium ion cell
12 Electrode
14 Electrode
16 Separator
161 Conductive sensor layer
162 Insulation layer
18 Electrolyte
20 Resistance measuring device
22 Battery management unit
24 Dendrite
26 Foreign body

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A lithium ion cell, comprising:
two electrodes of differing polarity located opposite one another;
a porous separator permeable to lithium ions, the separator separating the two electrodes from one another, wherein
the separator is configured as an at least three-layer composite element, one of the three layers of the separator is an electrically conductive porous sensor layer,
the electrically conductive porous sensor layer is flanked on each side by an electronically insulating layer permeable to lithium ions, and
the electrically conductive porous sensor layer is connected via a resistance measuring device to at least one of the two electrodes.

2. The lithium ion cell according to claim 1, wherein the electrically conductive porous sensor layer is composed of an electrically conductive polymer material.

3. The lithium ion cell according to claim 2, wherein the electrically conductive polymer material comprises a polyaniline, polypyrrole or a polythiophene.

4. The lithium ion cell according to claim 1, wherein the electrically conductive porous sensor layer is composed of a metallically modified, nonconducting polymer material.

5. The lithium ion cell according to claim 2, wherein the electrically conductive polymer material is configured as a porous membrane.

6. The lithium ion cell according to claim 4, wherein the metallically modified, nonconductive polymer material is configured as a porous membrane.

7. The lithium ion cell according to claim 5, wherein the polymer material is configured as a stretched film.

8. The lithium ion cell according to claim 6, wherein the polymer material is configured as a stretched film.

9. The lithium ion cell according to claim 1, further comprising:
a battery housing surrounding the two electrodes and the separator, wherein
the resistance measuring device together with a control connected thereto and a transmitter unit connected to the control is integrated at a distance from the two electrodes into the battery housing, and
resistance measurements by the resistance measuring device are initiatable via the control, and resistance values determined by the resistance measuring device, or a parameter derived from the resistance values, is communicatable via the transmitter unit to an external receiver unit.

10. The lithium ion cell according to claim 9, wherein the resistance measuring device, the control, and the transmitter unit are jointly formed as an integrated circuit.

11. The lithium ion cell according to claim 9, wherein
the transmitter unit is configured as a radio transmitter unit so that the resistance values, or the parameter derived therefrom, is communicatable via radio signal to the external receiver unit.

12. The lithium ion cell according to claim 10, wherein
the transmitter unit is configured as a radio transmitter unit so that the resistance values, or the parameter derived therefrom, is communicatable via radio signal to the external receiver unit.

13. The lithium ion cell according to claim 9, wherein
the transmitter unit comprises a modulator and is connected to a direct current outlet lead of one of the two electrodes such that the resistance values, or the parameter derived therefrom, is communicatable as a modulated signal imposed on a direct current voltage of the electrode to the external receiver unit.

14. The lithium ion cell according to claim 10, wherein
the transmitter unit comprises a modulator and is connected to a direct current outlet lead of one of the two electrodes such that the resistance values, or the parameter derived therefrom, is communicatable as a modulated signal imposed on a direct current voltage of the electrode to the external receiver unit.
